(19) United States
(12) Patent Application Publication
(10) Pub. No.: US 2018/0276986 A1
(43) Pub. Date: Sep. 27, 2018

(54) VEHICLE-TO-HUMAN COMMUNICATION IN AN AUTONOMOUS VEHICLE OPERATION

(71) Applicant: Toyota Research Institute, Inc., Los Altos, CA (US)

(72) Inventor: Michael J. Delp, Ann Arbor, MI (US)

(21) Appl. No.: 15/465,847

(22) Filed: Mar. 22, 2017

(51) Int. Cl. G08G 1/005; G05D 1/00; G08G 1/09

(52) U.S. Cl. CPC G08G 1/005; G08G 1/091; G05D 1/0088

(57) ABSTRACT

A device and method for autonomous vehicle-to-human communications are disclosed. Upon detecting a human traffic participant being proximal to a traffic yield condition of a vehicle planned route, generating a message for broadcast to the human traffic participant and sensing whether the human traffic participant acknowledges a receipt of the message. When sensing that the human traffic participant acknowledges receipt of the message, generating a vehicle acknowledgment message for broadcast to the pedestrian.

### FIELD

The subject matter described herein relates in general to vehicle-to-human communications and, more particularly, to the autonomous vehicle sensing of human acknowledgment to vehicle messaging content.

### BACKGROUND

Vehicular computer vision systems and radar systems have generally provided a capability of sensing people, and sensing respective human gestures from within other vehicles and/or pedestrians. Also, external vehicle displays have been generally used for generally delivering message content intended for human traffic participants, such as pedestrians, bicyclists, skate boarders, other drivers, etc. In the context of autonomous vehicle-to-human communications, however, the responsive component to the communications have been lacking with respect to acknowledgement by humans to message content by an autonomous vehicle. Accordingly, a device and method are desired by which a human's actions may be ascertainable by determining an acknowledgement in a vehicle-to-human communication.

### SUMMARY

A device and method for vehicle-to-human communications including a human traffic participant acknowledgment are disclosed.

In one implementation, a method for vehicle-to-human communication for autonomous vehicle operation is disclosed. Upon detecting a human traffic participant being proximal to a traffic yield condition of a vehicle planned route, generating a message indicating a vehicle intent for broadcast to the human traffic participant and sensing whether the human traffic participant acknowledges a receipt of the message. When sensing that the human traffic participant acknowledges receipt of the message, generating a vehicle acknowledgment message for broadcast to the pedestrian. In another implementation, a vehicle control unit for providing vehicle-to-human communications in autonomous vehicle operation is disclosed. The vehicle control unit includes a processor, and a memory communicably coupled to the processor and to a plurality of vehicle sensor devices. The memory storing a vehicular operations module including instructions that when executed cause the processor to generate vehicle location data including a traffic yield condition from vehicle planned route data and sensor data, and a traffic yield condition module including instructions that when executed cause the processor to receive the vehicle location data and human traffic participant data, based on at least some of the plurality of vehicle sensor devices, to detect a human traffic participant being proximal to the traffic yield condition. When the human traffic participant being proximal to the traffic yield condition, generate message data indicating a vehicle intent for delivery to the human traffic participant. The memory stores an acknowledgment confirmation module including instructions that when executed cause the processor to sense, based on the at least some of the plurality of vehicle sensor devices, whether the pedestrian acknowledges a receipt of the message. Sensing whether the pedestrian acknowledges receipt may include at least one of determining pedestrian attention data, and determining pedestrian conduct data responsive to the message. When sensing that the pedestrian acknowledges the receipt of the message, generating a vehicle acknowledgment message for delivery to the pedestrian.

### BRIEF DESCRIPTION OF THE DRAWINGS

The description makes reference to the accompanying drawings wherein like reference numerals refer to like parts throughout the several views, and wherein:

FIG. 1 is a schematic illustration of a vehicle including a vehicle control unit;

FIG. 2 is a block diagram of the vehicle control unit of FIG. 1 in the context of a vehicle network environment;

FIG. 3 is a block diagram of the vehicle control unit of FIG. 1;

FIG. 4 is a functional block diagram of a vehicle-to-human communication module of the vehicle control unit;

FIG. 5 illustrates an example of the vehicle-to-human communication module of FIG. 4 operable in a congested environment; and

FIG. 6 shows an example process for a vehicle-to-human communication module for use in autonomous vehicle operations.

### DETAILED DESCRIPTION

An autonomous vehicle device and method are provided to provide vehicle-to-human communications with human traffic participants in traffic yield conditions.

In general, vehicle-to-human communications may be employed to deter human traffic participants (such as pedestrians, bicyclists, manually-operated vehicles, etc.) from crossing in front of a vehicle under traffic yield conditions. Conventionally, human receptiveness and/or recognition may be gauged in response to indications of an autonomous vehicle's intent.

Vehicle-to-human communication may be facilitated by (a) a non-threatening appearance of an autonomously-operated vehicle, (b) enhanced interaction of the autonomously-operated vehicle with vehicle passengers, and (c) bi-directional interaction of the autonomously-operated vehicle with drivers of manually-operated vehicles, pedestrians, bicyclists, etc. (referred to generally as “human traffic participants”).

In the example of vehicle-to-human communication with people outside an autonomously-operated vehicle, familiar vehicle signaling such as blinkers, brake lights, and hazard lights though automated may still be implemented. Because passengers and/or operators of autonomously-operated vehicles may be disengaged from control of a vehicle, such vehicles may lack human gestures and cues used by people to navigate roadways—such as eye contact, waving ahead at an intersection, etc.

Moreover, an aspect considered by an autonomously-operated vehicle is whether its outgoing communications (such as external displays, announcements, vehicle light signals, etc.) have been received and understood by a human traffic participant.

Also, even when implemented, human traffic participants may likely disregard and/or ignore exterior displays advising of a vehicle's intended and/or present motion (such as speed, acceleration, deceleration, etc.), relying instead on legacy behaviors such as guessing an approaching vehicle's speed, and based on this guess, infer a flawed likelihood that they could dart across the roadway in time to avoid being struck by an autonomously-operated vehicle. Accordingly, vehicle-to-human communications are sought to deter such legacy behaviors. Such vehicle-to-human communications may be used to develop a bi-directional machine-to-human dialog

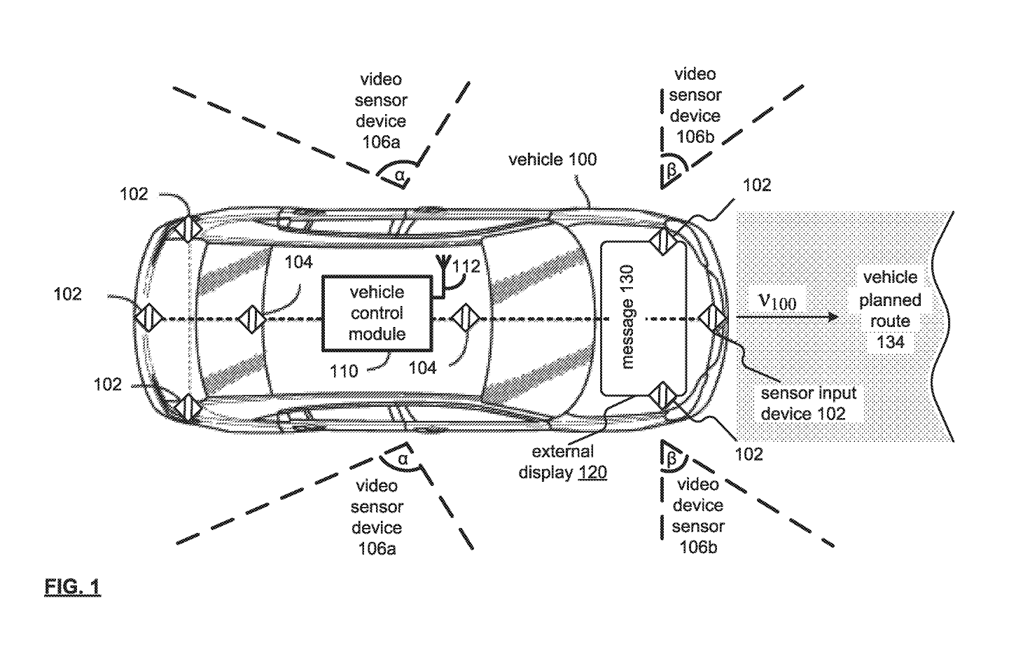

FIG. 1 is a schematic illustration of a vehicle 100 including a vehicle control unit 110. A plurality of sensor devices 102, 104, 106a and 106b are in communication with the control unit 110 to access a vehicle environment. As may be appreciated, the vehicle 100 may also be an automobile, light truck, cargo transport, or any other passenger or non-passenger vehicle.

The plurality of sensor devices 102, 104 and/or 106 may be positioned on the outer surface of the vehicle 100, or may be positioned in a concealed fashion for aesthetic purposes with regard to the vehicle. Moreover, the sensors may operate at frequencies in which the vehicle body or portions thereof appear transparent to the respective sensor device.

Communication between the sensors and vehicle control units, including vehicle control unit 110, may be on a bus basis, and may also be used or operated by other systems of the vehicle 100. For example, the sensor devices 102, 104 and/or 106 may be coupled by a combination of network architectures such as a Body Electronic Area Network (BEAN), a Controller Area Network (CAN) bus configuration, an Audio Visual Communication-Local Area Network (AVC-LAN) configuration, and/or other combinations of additional communication-system architectures to provide communications between devices and systems of the vehicle 100.

The sensor devices may include sensor input devices 102, audible sensor devices 104, and video sensor devices 106a and 106b. The outputs of the example sensor devices 102, 104, and/or 106 may be used by the vehicle control unit 110 to detect vehicular transition events, which may then predict a vehicle-user input response. The predicted vehicle-user input response may then be used by the vehicle control unit 110 to emphasize a subset of presented user interface elements for facilitating a vehicle-user input.

The sensor input devices 102, by way of example, may provide tactile or relational changes in the ambient conditions of the vehicle, such as an approaching pedestrian, cyclist, object, vehicle, road debris, and other such vehicle obstacles (or potential vehicle obstacles).

The sensor input devices 102 may be provided by a Light Detection and Ranging (LIDAR) system, in which the sensor input devices 102 may capture data related to laser light returns from physical objects in the environment of the vehicle 100. The sensory input devices 102 may also include a combination of lasers (LIDAR) and milliwave radar devices.

The audible sensor devices 104 may provide audible sensing of the ambient conditions of the vehicle 100. With speech recognition capability, the audible sensor devices 104 may receive instructions to move, or to receive other such directions. The audible sensor devices 104 may be provided, for example, by a nano-electromechanical system (NEMS) or micro-electromechanical system (MEMS) audio sensor omnidirectional digital microphone, a sound-triggered digital microphone, etc.

As may be appreciated, a vehicle interior space may be noise-insulated to improve a passenger and/or operator's travel experience. On the other hand, utility vehicles (such as trucks, construction vehicles, etc.) have little noise insulation. The vehicle interior may be filled with noise pollution from friction from moving air, the roadway, or a construction site. Audible sensor devices 104, which may be mounted within an interior and/or an exterior of the vehicle 100, may provide sensor data relating to pedestrians, such as an approaching person, cyclist, object, vehicle, and other such vehicle obstacles (or potential vehicle obstacles), and such data be conveyed via a sensor control unit to vehicle control unit 110.

One or more of the sensor input devices 106 may be configured to capture changes in velocity, acceleration, and/or distance to these objects in the ambient conditions of the vehicle 100, as well as the angle of approach. The video sensor devices 106a and 106b include sensing associated fields of view.

For the example of FIG. 1, the video sensor device 106a has a three-dimensional field-of-view of angle-α, and the video sensor device 106b has a three-dimensional field-of-view of angle-β, with each video sensor having a sensor range for video detection.

In the various driving modes, the examples of the placement of the video sensor devices 106a for blind-spot visual sensing (such as for another vehicle adjacent the vehicle 100) relative to the vehicle user, and the video sensor devices 106b are positioned for forward periphery visual sensing (such as for objects outside the forward view of a vehicle user, such as a pedestrian, cyclist, vehicle, road debris, etc.).

For controlling data input from the sensors 102, 104 and/or 106, the respective sensitivity and focus of each of the sensor devices may be adjusted to limit data acquisition based upon speed, terrain, activity density around the vehicle, etc.

For example, though the field-of-view angles of the video sensor devices 106a and 106b may be in a fixed relation to the vehicle 100, the field-of-view angles may be adaptively increased and/or decreased based upon a vehicle driving mode. For example, a highway driving mode may cause the sensor devices less of the ambient conditions in view of the more rapidly changing conditions relative to the vehicle 100, while a residential driving mode to take in more of the ambient conditions that may change rapidly (such as a pedestrian that may intercept a vehicle stop range by crossing in front of the vehicle 100, etc.).

The sensor devices 102, 104 and 106 may, alone or in combination, operate to capture depth images or otherwise generating depth information for a captured image. For example, the sensor devices 102, 104 and 106 may configured to capture images (visual and non-visual spectrum wavelengths, audible and non-audible wavelengths, etc.).

In this aspect, the sensor devices 102, 104 and 106 are operable to determine distance vector measurements of objects in the environment of vehicle 100. For example, the sensor devices 102, 104 and 106 depth camera 128 may be configured to sense and/or analyze structured light, time of flight (e.g., of signals for Doppler sensing), light detection and ranging (LIDAR), light fields, and other information to determine depth/distance and direction of objects.

The sensor devices 102, 104 and 106 may also be configured to capture color images. For example, the depth camera 128 may have a RGB-D (red-green-blue-depth) sensor(s) or similar imaging sensor(s) that may capture images including four channels—three color channels and a depth channel.

Alternatively, in some embodiments, the vehicle control unit 110 may be operable to designate sensor devices 102, 104 and 106 with different imaging data functions. For example, the vehicle control unit 110 may designate one set of sensor devices for color imagery capture, designate another set of sensor devices to capture object distance vector data, designate (or re-purpose) yet another set of sensor devices to determine specific object characteristics, such as pedestrian attention data, pedestrian conduct data, etc.

For simplicity, terms referring to “RGB imagery,” “color imagery,” and/or “2D imagery” may refer to an image based on the color/grayscale channels (e.g., from the RBG stream) of an image. Terms referring to a “depth image” may refer to a corresponding image based at least in part on the depth channel/stream of the image.

As may be appreciated, the vehicle 100 may also include options for operating in manual mode, autonomous mode, and/or driver-assist mode. When the vehicle 100 is in manual mode, the driver manually controls the vehicle control unit modules, such as a propulsion module, a steering module, a stability control module, a navigation module, an energy module, and any other modules that can control various vehicle functions (such as the vehicle climate functions, entertainment functions, etc.). As may be appreciated, a human driver engaged with operation of the vehicle 100 may implement human-based social and/or cultural gestures and cues used to navigate roadways—such as eye contact, waving ahead at an intersection, etc.

In autonomous mode, a computing device, which may be provided by the vehicle control unit 110, or in combination therewith, can be used to control one or more of the vehicle systems without the vehicle user's direct intervention. Some vehicles may also be equipped with a “driver-assist mode,” in which operation of the vehicle 100 can be shared between the vehicle user and a computing device. For example, the vehicle user can control certain aspects of the vehicle operation, such as steering, while the computing device can control other aspects of the vehicle operation, such as braking and acceleration. When the vehicle 100 is operating in autonomous (or driver-assist) mode, the computing device 100 issues commands to the various vehicle control unit modules to direct their operation, rather than such vehicle systems being controlled by the vehicle user.

As may be appreciated, in an autonomous and/or driver-assist mode of operation, a human driver may be less engaged and/or focused with control of the vehicle 100. Accordingly, human-based gestures and/or cues may not be available for navigating roadways with pedestrians—such as eye contact, waving ahead at an intersection, etc.

Still referring to FIG. 1, the vehicle 100, when in motion at velocity V₁₀₀, may have a vehicle planned route 134. The vehicle planned route 134 may be based on a vehicle start point and destination point, with the vehicle control unit 110 being operable to determine the route logistics to achieve the destination. For example, the vehicle control unit 110 may operate to have a general travel route overview being the quickest to a destination as compared to other travel route options based on traffic flow, user preferences, fuel efficiency, etc.

The vehicle 100 may operate to broadcast a message 130 to a human traffic participant through, for example, an external display 120, an external audio system, vehicle blinker lights, vehicle brake lights, vehicle hazard lights, vehicle head lights, etc., and/or combinations thereof.

As shown in FIG. 1, the vehicle control unit 110 may be configured to provide wireless communication 122 through an antenna 120, for communications with other vehicles (vehicle-to-vehicle (V2V) communication), with infrastructures (vehicle-to-infrastructure (V2I) infrastructure), with a network cloud, cellular data services, etc.

The vehicle 100 may also include an external display 120. In the example of FIG. 1, display 120 is illustrated as located on the hood of vehicle 100, and operable to display content of message 130.

As may be appreciated, multiple displays may be positioned on the vehicle body surfaces, such as along one or more of the sides of vehicle 100 (including the roof, along the back, etc. The external display 120 may broadcast message content to the pedestrian relating to operation and/or “intention” information of vehicle 100, such as warnings of an impact, likelihood that by crossing in front of the vehicle 100 (that is intercepting the vehicle stop range 134) the pedestrian risks injury, that the vehicle 100 is “continuing” travel, etc., while a vehicle 526 in the adjacent vehicle travel land 505

An example display content may include a pedestrian icon having a “don't” circle and cross line, indicating that the vehicle 100 is not yielding, or may be discontinuing yielding at a traffic yield condition. In the alternative, for manually-operated vehicles, an example content may be a graphic image of progressive arrow design indicating motion by the autonomous vehicle 100.

A human traffic participant (such as pedestrian, bicyclist, vehicle driver, etc.) may attempt a dialogue with the vehicle 100, through gaze tracking, motion recognition (e.g., waving, stopping outside and/or not-intersecting the vehicle planned route 134, etc.). In confirmation, the vehicle 100 may respond by generating a vehicle acknowledgment message for broadcast to the human traffic participant.

Also, the external display 120 may display notifications relating to human traffic participant awareness, such as when the vehicle 100 approaches, or is stopped at, a cross-walk for a traffic yield condition. For example, the external display 120 may broadcast a “safe to cross” and/or “go ahead” display to human traffic participants that may cross and/or enter the vehicle planned route 134 of the vehicle 100.

As may be appreciated, messages may be broadcast by the external display 120 as static and/or dynamic images that may include different colors, static patterns, dynamic patterns, and/or combinations thereof. Also, the broadcast message 130 may implement a directed-perspective based on the point-of-view of the intended recipient (such as a pedestrian), taking into consideration the distance, direction, blind-spots, etc., that may relate to an intended human recipient.

A directed-perspective may be understood as relating to the manner by which spatial attributes of the broadcast message, as depicted through the external display 120, appear to the eye of the intended recipient. That is, in the context of a two-dimensional display such as external display 120, the broadcast message may be presented as an undistorted impression of height, width, depth, and position of an image when viewed by the intended recipient.

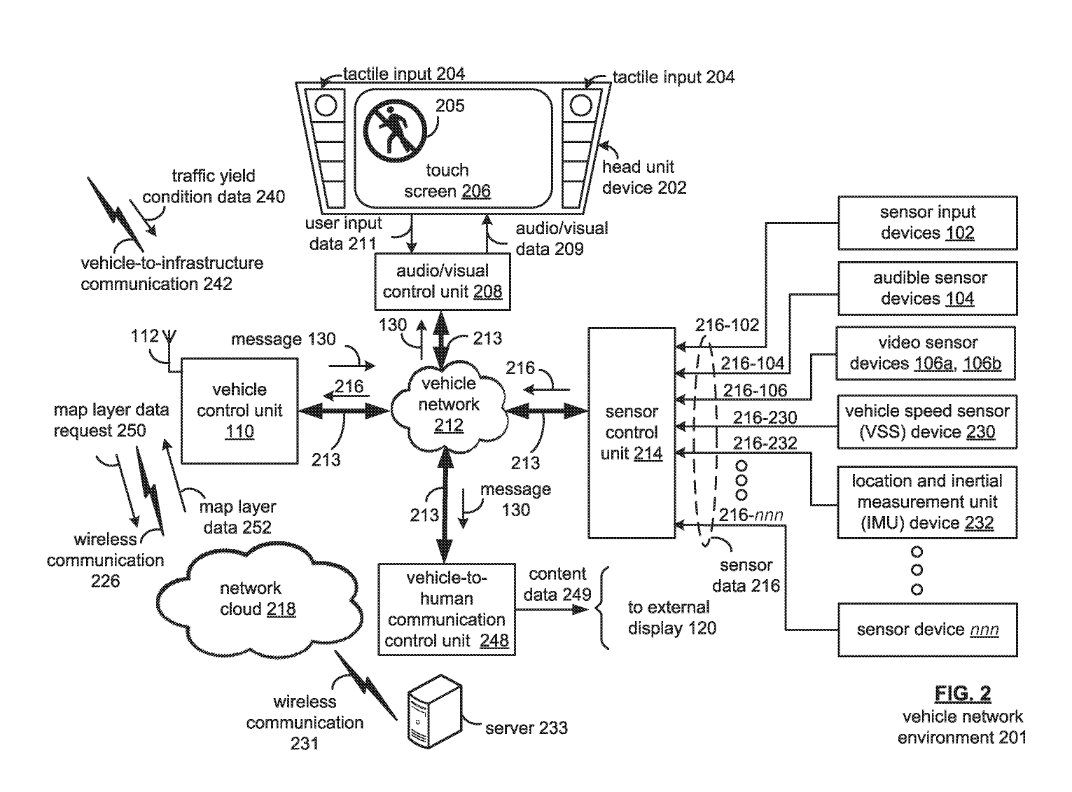

The vehicle control unit 110 may operate to sense a human traffic participant acknowledgment responsive to the message 130. In operation, the vehicle control unit 110 may operate to sense whether a human traffic participant comprehends, understands, and responds in accordance with the visual content, audible content, and/or haptic content of the message 130, based on (a) determining the human traffic participant's attention to the message 130, and (b) determining the human traffic participant's conduct in view of the message 130. Aspects underlying vehicle-to-human communications and/or dialogues are discussed in detail with reference to FIGS. 2-6.

Referring now to FIG. 2, a block diagram of a vehicle control unit 110 in the context of a vehicle network environment 201 is provided. While the vehicle control unit 110 is depicted in abstract with other vehicular components, the vehicle control unit 110 may be combined with the system components of the vehicle 100 (see FIG. 1).

The vehicle control unit 110 may provide vehicle-to-human communication via a head unit device 202, and via a vehicle-to-human communication control unit 248. The head unit device 202 may operate to provide communications to passengers and/or operators of the vehicle 100 via the touch screen 206.

The vehicle-to-human communication control unit 248 may operate to provide communications to persons outside the vehicle 100, such as via the external display 120, the wireless communication 122, vehicle external speakers, vehicle blinker lights, vehicle brake lights, vehicle hazard lights, vehicle head lights, etc., and/or combinations thereof.

As shown in FIG. 2, the vehicle control unit 110 communicates with the head unit device 202 via a communication path 213, and may also be wirelessly coupled with a network cloud 218 via the antenna 120 and wireless communication 226. From network cloud 218, a wireless communication 231 provides communication access to a server 233.

In operation, the vehicle control unit 110 may operate to detect a human traffic participant adjacent a traffic yield condition of a vehicle planned route 134 (FIG. 1).

With respect to autonomous vehicle operation, the vehicle control unit 110 may be operable to retrieve location data for the vehicle 100, via a global positioning satellite (GPS) data, and generate a request 250, based on the location data, for map layer data 252 via the server 233. The vehicle control unit 110 may determine from the map layer data 252 near real-time (NRT) traffic conditions, such as a general present traffic speed for roadway relative to a free-flowing traffic speed, traffic signal locations, traffic yield conditions, etc.

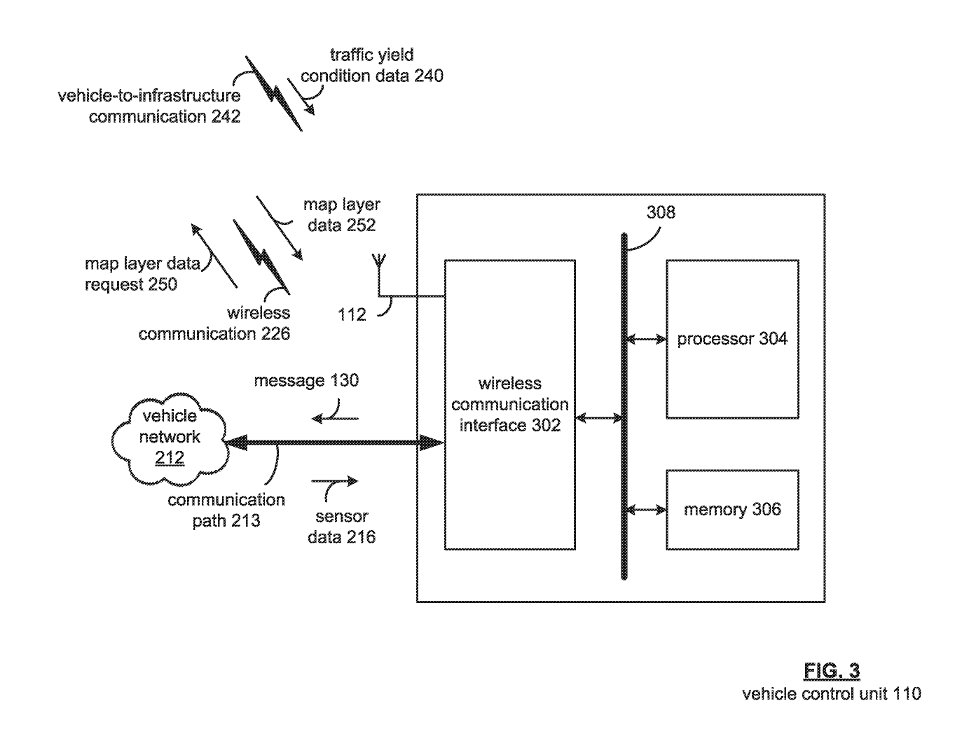

Traffic yield conditions may be understood as an implementation of right-of-way rules for traffic participant safety (autonomous vehicles as well as human drivers, pedestrians, bicyclists, etc.). A traffic yield condition may generally be present upon coming to a stop at a controlled and/or uncontrolled intersections, and may be indicated via map layer data 252, as well as vehicle-to-infrastructure communication 242 via traffic yield condition data 240. Traffic yield conditions are discussed in detail with reference to FIGS. 3-6.

Through the sensor control unit 214, the vehicle control unit 110 may access sensor data 216-102 of the sensor input device 102, sensor data 216-104 of the audible sensor device 104, sensor data 216-106 of the video sensor device 106, vehicle speed data 216-230 of the vehicle speed sensor (VSS) device 230, location and inertial measurement unit (IMU) data 216-232 of the IMU device 232, and additional useful sensor data 216-nnn of the sensor device nnn, as further technologies and configurations may be available.

As may be appreciated, the vehicle speed sensor (VSS) device 230 may operate to determine a vehicle speed to produce vehicle speed data 216-230. The VSS device may measure a vehicle speed via a transmission/transaxle output or wheel speed. The vehicle control unit 110 may utilize data 216-230 as relating to a rate of approach to a traffic yield condition, and to generate an action message 130 for broadcast to a human traffic participant.

Also, the location and IMU device 232 may operate to measure and report the force, angular rate, etc., of the vehicle 100 through combinations of accelerometers, gyroscopes, and sometimes magnetometers, for determining changes in movement of the vehicle 100. A location aspect may operate to geographically track the vehicle 100, such as via a global positioning system (GPS) based technologies, as well as to operate relative to map layer data 252 data that may be retrieved via a third party server 233. The device 232 may be configured as an IMU-enabled GPS device, in which the IMU device component may provide operability to a location device, such as a GPS receiver, to work when GPS-signals are unavailable, such as in tunnels, inside parking garages, electronic interference, etc. The vehicle control unit 110 may utilize data 216-232 as relating to a location and manner of approach to a traffic yield condition, and to generate an action message 130 for broadcast to a human traffic participant.

The sensor data 216 may operate to permit environment detection external to the vehicle 100, such as for example, human traffic participants, such as vehicles ahead of the vehicle 100, as well as interaction of the autonomously-operated vehicle 100 with human drivers, pedestrians, bicyclists, etc. Accordingly, the vehicle control unit 110 may receive the sensor data 216 to assess the environment of the vehicle 100, and relative location and manner of approach to a traffic yield condition, and to generate an action message 130 for broadcast to a human traffic participant.

With the sensor data 216, the vehicle control unit 110 may operate to identify a traffic lane in relation to a plurality of traffic lanes for autonomous operation in a roadway, and may also operate to detect a human traffic participant adjacent a traffic yield condition of a vehicle planned route of the vehicle 100.

Upon detecting a human traffic participant, the vehicle control unit 110 may operate to generate an action message 130 for broadcast to the human traffic participant. The message 130 may be conveyed via the vehicle network 212 through the communication path(es) 213 to audio/visual control unit 208, to the vehicle-to-human communication control unit 248, as well as vehicle-to-passenger communication via the head unit device 202.

Still referring to FIG. 2, the head unit device 202 includes, for example, tactile input 204 and a touch screen 206. The touch screen 206 operates to provide visual output or graphic user interfaces such as, for example, maps, navigation, entertainment, information, infotainment, and/or combinations thereof, which may be based on the map layer data 252, vehicle speed sensor (VSS) data 216-230, and location and inertial measurement unit (IMU) device 232.

For example, when the vehicle control unit 110 generates a message 130, the audio/visual control unit 208 may generate audio/visual data 209 that displays a status icon 205 based on the content of the message 130, such as a “no crossing” icon, a “moving” icon, and/or other forms of visual content, as well as audible content messaging indicating that the vehicle 100 movement status. In this manner, when the vehicle 100 is in autonomous operation, status indications may be visually and/or audibly presented to limit unnecessary anxiety/uncertainty to the vehicle passengers and/or operator.

The touch screen 206 may include mediums capable of transmitting an optical and/or visual output such as, for example, a cathode ray tube, light emitting diodes, a liquid crystal display, a plasma display, etc. Moreover, the touch screen 206 may, in addition to providing visual information, detect the presence and location of a tactile input upon a surface of or adjacent to the display.

The touch screen 206 and the tactile input 204 may be combined as a single module, and may operate as an audio head unit or an infotainment system of the vehicle 100. The touch screen 206 and the tactile input 204 can be separate from one another and operate as a single module by exchanging signals via the communication path 104.

The vehicle-to-human communication control unit 248 may operate to provide communications to human traffic participants outside the vehicle 100, such as via the external display 120, vehicle external speakers, vehicle blinker lights, vehicle brake lights, vehicle hazard lights, vehicle head lights, etc., and/or a combination thereof.

As shown in FIG. 2, the vehicle control unit 110 communicates with the vehicle-to-human communication control unit 248 via a communication path 213.

The vehicle-to-human communication control unit 249 may operate to receive message 130, and produce from the message 130 content data 249 for broadcast to persons outside the vehicle 100. Broadcast of the content data 249 may be by various content mediums, such as via the external display 120, vehicle external speakers, vehicle blinker lights, vehicle brake lights, vehicle hazard lights, vehicle head lights, etc., and/or a combination thereof.

As may be appreciated, the communication path 213 of the vehicle network 212 may be formed a medium suitable for transmitting a signal such as, for example, conductive wires, conductive traces, optical waveguides, or the like. Moreover, the communication path 213 can be formed from a combination of mediums capable of transmitting signals. In one embodiment, the communication path 213 may include a combination of conductive traces, conductive wires, connectors, and buses that cooperate to permit the transmission of electrical data signals to components such as processors, memories, sensors, input devices, output devices, and communication devices.

Accordingly, the communication path 213 may be provided by a vehicle bus, or combinations thereof, such as for example, a Body Electronic Area Network (BEAN), a Controller Area Network (CAN) bus configuration, an Audio Visual Communication-Local Area Network (AVC-LAN) configuration, a Local Interconnect Network (LIN) configuration, a Vehicle Area Network (VAN) bus, a vehicle Ethernet LAN, a vehicle wireless LAN and/or other combinations of additional communication-system architectures to provide communications between devices and systems of the vehicle 100.

The term “signal” relates to a waveform (e.g., electrical, optical, magnetic, mechanical or electromagnetic), such as DC, AC, sinusoidal-wave, triangular-wave, square-wave, vibration, and the like, capable of traveling through at least some of the mediums described herein.

The vehicle network 212 may be communicatively coupled to receive signals from global positioning system satellites, such as via the antenna 120 of the vehicle control unit 110, or other such vehicle antenna (not shown). The antenna 120 may include one or more conductive elements that interact with electromagnetic signals transmitted by global positioning system satellites. The received signals may be transformed into a data signal indicative of the location (for example, latitude and longitude positions), and further indicative of the positioning of the vehicle with respect to road data, in which a vehicle position can be indicated on a map displayed via the touch screen 206.

The vehicle-to-human communication control unit 248 may operate to provide communications to persons outside the vehicle 100, such as via the external display 120, vehicle external speakers, vehicle blinker lights, vehicle brake lights, vehicle hazard lights, vehicle head lights, etc., and/or a combination thereof.

As may be appreciated, the wireless communication 226 and 242 may be based on one or many wireless communication system specifications. For example, wireless communication systems may operate in accordance with one or more standards specifications including, but not limited to, 3GPP (3rd Generation Partnership Project), 4GPP (4th Generation Partnership Project), 5GPP (5th Generation Partnership Project), LTE (long term evolution), LTE Advanced, RFID, IEEE 802.11, Bluetooth, AMPS (advanced mobile phone services), digital AMPS, GSM (global system for mobile communications), CDMA (code division multiple access), LMDS (local multi-point distribution systems), MMDS (multi-channel-multi-point distribution systems), IrDA, Wireless USB, Z-Wave, ZigBee, and/or variations thereof.

Also, in reference to FIG. 2, a server 233 may be communicatively coupled to the network cloud 218 via wireless communication 231. The server 233 may include third party servers that are associated with applications that running and/or executed on the head unit device 202, etc. For example, map data layer data 252 may be executing on the head unit device 202 and further include GPS location data to identify the location of the vehicle 100 in a graphic map display.

The server 233 may be operated by an organization that provides the application, such as a mapping application and map application layer data including roadway information data, traffic layer data, geolocation layer data, etc. Map layer data 252 may be provided in a Route Network Description File (RNDF) format.

A Route Network Description File specifies, for example, accessible road segments and provides information such as waypoints, stop sign locations, lane widths, checkpoint locations, parking spot locations, traffic yield conditions, etc. Servers such as server 233 may also provide data as Mission Description Files (MDF) for autonomous vehicle operation by vehicle 100 by, for example, vehicle control unit 110 and/or a combination of vehicle control units 110.

A Mission Description Files (MDF) may operate to specify checkpoints to reach in a mission, such as along a vehicle planned route 134. It should be understood that the devices discussed herein may be communicatively coupled to a number of servers by way of the network cloud 218, and moreover, that the vehicle planned route 134 may be dynamically adjusted based on driving conditions (such as roadway congestion, faster routes available, toll road fees, etc.).

FIG. 3 is a block diagram of a vehicle control unit 110, which includes a wireless communication interface 302, a processor 304, and memory 306, that are communicatively coupled via a bus 308.

The processor 304 of the vehicle control unit 110 can be a conventional central processing unit or any other type of device, or multiple devices, capable of manipulating or processing information. As may be appreciated, processor 304 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions.

The memory and/or memory element 306 may be a single memory device, a plurality of memory devices, and/or embedded circuitry of the processing module 804. Such a memory device may be a read-only memory, random access memory, volatile memory, non-volatile memory, static memory, dynamic memory, flash memory, cache memory, and/or any device that stores digital information. Furthermore, arrangements described herein may take the form of a computer program product embodied in one or more computer-readable media having computer-readable program code embodied, e.g., stored, thereon.

Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. In the context of this document, a computer-readable storage medium may be any tangible medium that can contain, or store a program for use by or in connection with an instruction execution system, apparatus, or device.

The memory 306 is capable of storing machine readable instructions, or instructions, such that the machine readable instructions can be accessed by the processor 804. The machine readable instructions can comprise logic or algorithm(s) written in programming languages, and generations thereof, (e.g., 1GL, 2GL, 3GL, 4GL, or 5GL) such as, for example, machine language that may be directly executed by the processor 304, or assembly language, object-oriented programming (OOP), scripting languages, microcode, etc., that may be compiled or assembled into machine readable instructions and stored on the memory 306. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods and devices described herein may be implemented in any conventional computer programming language, as pre-programmed hardware elements, or as a combination of hardware and software components.

Note that when the processor 304 may include more than one processing device, the processing devices may be centrally located (e.g., directly coupled together via a wired and/or wireless bus structure) or may be distributed located (e.g., cloud computing via indirect coupling via a local area network and/or a wide area network). Further note that when the processor 304 implements one or more of its functions via a state machine, analog circuitry, digital circuitry, and/or logic circuitry, the memory and/or memory element storing the corresponding operational instructions may be embedded within, or external to, the circuitry including the state machine, analog circuitry, digital circuitry, and/or logic circuitry.

Still further note that, the memory 306 stores, and the processor 304 executes, hard coded and/or operational instructions corresponding to at least some of the steps and/or functions illustrated in FIGS. 1-6. The vehicle control unit 110 is operable to receive, via the wireless communication interface 302 and communication path 213, sensor data 216 including at least one of vehicle operational data (such as speed) and/or vehicle user biometric data (such as object detection, pedestrian detection, gaze detection, face detection, etc.).

In operation, the vehicle control unit 110 may operate to provide vehicle-to-human communications. The vehicle control unit 110 may operate to determine a vehicle stop range for the vehicle, and detect whether a motion by a pedestrian operates to intercept the vehicle stop range. When the motion by the pedestrian operates to intercept the vehicle stop range, the vehicle control unit 110 may warn the pedestrian of the intercept course by generating a message for broadcast to the pedestrian.

For vehicle-to-human communications, the vehicle control unit 110 may operate to determine a dialogue with the human traffic participant (that is, a pedestrian, a bicyclist, a driver, etc.) may be present. That is, the vehicle control unit 110 may sense, via at least one vehicle sensor device, the a human's responsiveness to the message 130 with respect to a traffic yield condition of the vehicle planned route, which is discussed in detail with reference to FIGS. 3-6.

The vehicle 100 can include one or more modules, at least some of which are described herein. The modules can be implemented as computer-readable program code that, when executed by a processor 304, implement one or more of the various processes described herein. One or more of the modules can be a component of the processor(s) 304, or one or more of the modules can be executed on and/or distributed among other processing systems to which the processor(s) 304 is operatively connected. The modules can include instructions (e.g., program logic) executable by one or more processor(s) 604.

The wireless communications interface 302 generally governs and manages the data received via a vehicle network and/or the wireless communication 122. There is no restriction on the present disclosure operating on any particular hardware arrangement and therefore the basic features herein may be substituted, removed, added to, or otherwise modified for improved hardware and/or firmware arrangements as they may develop.

The antenna 120, with the wireless communications interface 302, operates to provide wireless communications with the vehicle control unit 110, including wireless communication 226 and 242.

Such wireless communications range from national and/or international cellular telephone systems to the Internet to point-to-point in-home wireless networks to radio frequency identification (RFID) systems. Each type of communication system is constructed, and hence operates, in accordance with one or more communication standards. For instance, wireless communication systems may operate in accordance with one or more standards including, but not limited to, 3GPP (3rd Generation Partnership Project), 4GPP (4th Generation Partnership Project), 5GPP (5th Generation Partnership Project), LTE (long term evolution), LTE Advanced, RFID, IEEE 802.11, Bluetooth, AMPS (advanced mobile phone services), digital AMPS, GSM (global system for mobile communications), CDMA (code division multiple access), LMDS (local multi-point distribution systems), MMDS (multi-channel-multi-point distribution systems), and/or variations thereof.

Other control units described with reference to FIG. 2, such as audio/visual control unit 208, sensor control unit 214, and vehicle-to-human communication control unit 248, may each also include a wireless communication interface 302, a processor 304, and memory 306, that are communicatively coupled via a bus 308 as described in FIG. 3. As may be appreciated, the various control units may be implemented in combination with each other and/or selected multiple combinations.

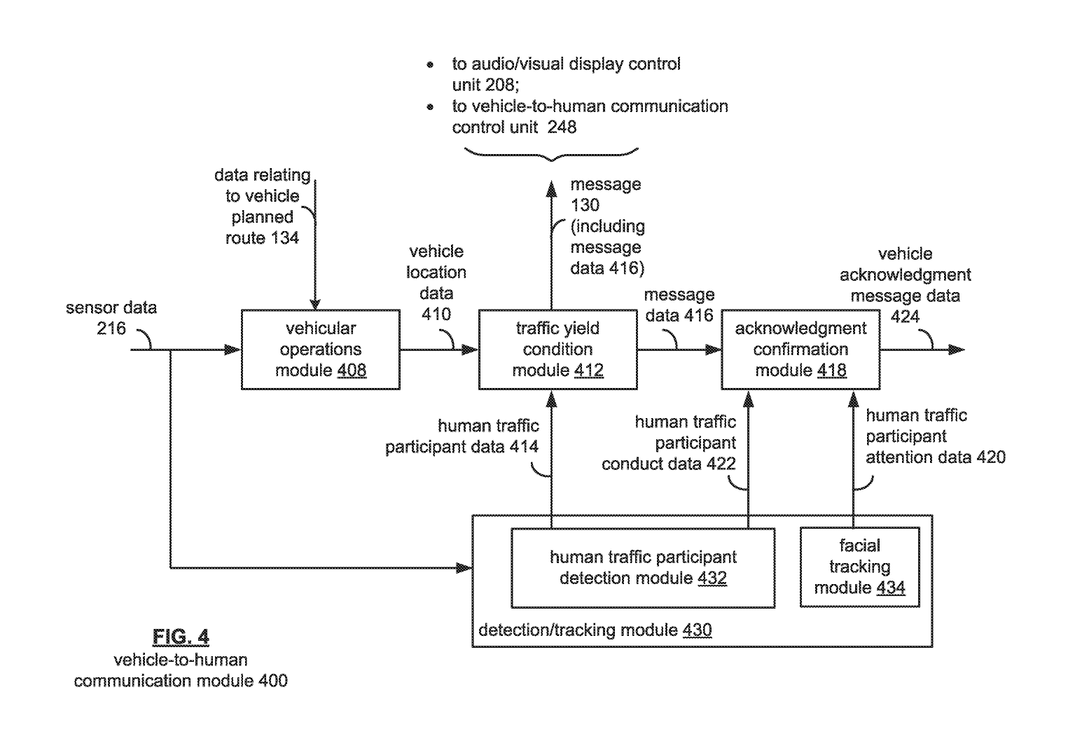

FIG. 4 illustrates a functional block diagram for a vehicle-to-human communication module 400 of the vehicle control unit 110. The vehicle-to-human communication module 400 may include vehicular operations module 408, an intercept determination module 412, an acknowledgment confirmation module 418, and a detection/tracking module 411.

The vehicular operations module 408 receives sensor data 216 which may include VSS data 216-232 and location and inertial measurement unit (IMU) data 216-232. In relation to the vehicle planned route 134, the vehicular operations module 4018 may produce vehicle location data 410.

In operation, from the perspective of a human traffic participant, such as a pedestrian, bicyclist, vehicle operator, etc., a natural and/or cultural pause may result while a human traffic participant receives information and/or feedback from the vehicle 100 via the vehicle-to-human communication module 400.

For example, under ideal operating conditions (such as dry pavement, sufficient tire tread, average brake pad wear, etc.), an average human driver on average may reduce the vehicle velocity V₁₀₀ at a rate of about fifteen feet-per-second for every second on approach to a traffic yield condition. Different human drivers may have varying stopping capability based on experience, age, eyesight, attentiveness, etc. Similarly, to mirror driving customs for a given geographic region, an autonomously-operated vehicle 100 may similarly operate to mimic an average human driver to match accepted customs and/or expectations by human traffic participants.

Traffic yield condition module 412 receives the vehicle location data 134, and human traffic participant data 414 from human traffic participant detection module 432 of the detection/tracking module 430. The human traffic participant detection module 432 may operate to detect a human traffic participant based on sensor data 216 (such as via sensor data 216-102, 216-104 and/or 216-106 of sensor devices 102, 104 and/or 106, respectively, of FIGS. 1 and 2).

For example, the sensor data 216 may provide image data from the sensor devices 102, 104, and/or 106. As an example, the human traffic participant detection module 432 may derive a depth map and appearance information (such as color contrasts, intensity, etc.) from the sensor data 216, and detect pedestrian candidate regions (such as via a bounded point cloud input of LIDAR-based sensor devices, image recognition via imaging-based sensor devices, etc.) based on a comparison with human shape models to render a detected pedestrian object, and position relative to the autonomous vehicle 100 (FIG. 1).

As may be appreciated, various object recognition methods may be used alone and/or in combination, such as an alignment methodology (e.g., using points, smooth contours, etc.), invariant properties methodology in which properties may be common to multiple views (e.g., color indexing, geometric hashing, moments, etc.), parts decomposition methodology (e.g., objects having natural parts, such as nose, eyes, mouth) for facial recognition, etc.

Other forms of human recognition may be implemented, such as via gaze tracking, eye tracking, etc. Generally vehicle sensor devices 102, 104 and/or 106 may operate to provide non-contact measurement of human eye motion. As may be appreciated, light waveforms (such as infrared frequency range), may be reflected from the eye and sensed by optical sensor, for example a video sensor device 106.

The vehicle control unit 110 may perform gaze detection by running windowed convolutions matching typical gaze patterns on the detected facial area to indicate when a face of a human traffic participant may be directed towards the vehicle. Once a person's eyes are located, a sufficiently powerful camera may track the center of the pupil for detecting detect gaze direction. Also, additional facial features may be included, such as eyebrow position, hairline position, ear position, etc. Such features may also be based on gaze recognition examples through machine learning based techniques (for example, convolutional neural networks, HOG detectors, random forests, support vector machines, etc.).

As may be appreciated, vehicle sensor devices 102, 104 and/or 106 may operate to locate the point of a human traffic participant's gaze, and tracking movement of the point-of-gaze. Such tracking may take place in open air environments and/or environments in which a gaze source may be behind vehicle windows, tints, eyeglasses, contacts, etc. Further granularity may be achieved through eye-tracking, in which upon detection of a point-of-gaze, motion of an eye relative to the head may be determined to detect the attention level of a human traffic participant to an action message 130.

The human traffic participant detection module 432 operates to track the human traffic participant for a sufficient time duration to determine a motion vector (that is, movement speed, and movement direction) of the detected human traffic participant. The vector is provided to the traffic yield condition module 412 as human traffic participant data 414.

The traffic yield condition module 412 may operate to detect whether a motion by a pedestrian may operate to intercept and/or cross the vehicle planned route 134 based on the human traffic participant data 414 and the vehicle location data 410.

When the traffic yield condition module 412 operates to detect a human traffic participant proximal to a traffic yield condition of the vehicle planned route 134, as may be based on the vehicle location data 4511 and the human traffic participant data 414, the traffic yield condition module 412 may operate to generate a message 130 (such as a multimedia message, a graphic image message, audible message, vehicle light pattern, etc.) for broadcast of message data 416 to the human traffic participant.

The message 130 may be provided, via a vehicle network environment 201 (FIG. 2) for broadcast via an audio/visual control unit 208 and/or a vehicle-to-human communication control unit 248.

Message data 416 of the message 130 may be provided by the traffic yield condition module 412 to the acknowledgement confirmation module 418 for detecting responsive behaviors by the human traffic participant to message data 416 of the message 130 when broadcast.

In the example of an undesired intercept by a pedestrian of the vehicle planned route 134 at a traffic yield condition, the desired action from the human traffic participant based on a vehicle-to-human communication with the vehicle control unit 110 via the module 400.

The acknowledgement confirmation module 418 operates to receive the message data 416 that may include the message content for the message 130 for broadcast to a pedestrian (such as a “no crossing,” “stop,” “yield,” etc.), graphic image(s) accompanied by audible warning and/or vehicle light patterns.

The acknowledgement confirmation module 418 may operate to sense whether human traffic participant acknowledges a receipt of the multimedia message by at least one of (a) human traffic participant conduct data 422, which may be produced by the human traffic participant detection module 432, and (b) human traffic participant attention data 420, which may be produced by a facial tracking module 418.

The facial tracking module 418 may operate to provide facial tracking based on various object recognition methods that may be used alone and/or in combination, such as an alignment methodology (e.g., using points, smooth contours, etc., for image recognition of a human face), invariant properties methodology in which properties may be common to multiple views (e.g., color indexing, geometric hashing, moments, etc.), parts decomposition methodology (e.g., objects having natural parts, such as nose, eyes, mouth) for facial recognition, etc. Object recognition for human facial directional-orientation may also be implemented through gaze tracking, eye tracking, etc., which may operate to indicate where a focus lies of a human traffic participant's attention.

Human traffic participant attention data 420 may operate to indicate that a pedestrian's focus lies with content of a broadcast of message 130 of the vehicle 100 by the looking, facing, gazing, gesturing, etc. towards the vehicle 100. Finer eye-tracking processes may be further implemented to determine a focal point to aspects of the vehicle 100, such as an external display 120 (FIG. 1), or direction towards the vehicle on an audible announcement.

Attention by the human traffic pedestrian. For example, a pedestrian and/or a bicyclist may gesture (such as be “waving on” towards the autonomous vehicle 100 to move on (that they will wait), to hold a hand-up, indicating for the vehicle to hold its position, a facial recognition/gaze that may infer acknowledgment of receipt of the message 130. Similar gestures, as well as vehicle lights (such as flashing the high-beams), may be used by a human vehicle operator to gesture to the vehicle 100.

These human gestures may infer a human traffic participant's intent via the acknowledgement confirmation module 418. For example, a human traffic participant may look towards the direction of vehicle 100, indicating some perception by the participant of the autonomous vehicle 100 at a crosswalk (at an intersection and/or crossing the roadway, and vehicle planned route 134). Though the option to a pedestrian is to cross (based on a the traffic yield condition), the pedestrian may gesture to “wave” the vehicle 100 on, or on the other hand, may gesture to “halt” while the pedestrian crosses the vehicle planned route 134 at the vehicle yield condition.

Also, though the human traffic participant attention data 420 may operate to indicate that the pedestrian appears to be providing attention to the message 130, the human traffic participant's conduct may be contrary to the message 130.

The human traffic participant conduct data 422 may operate to indicate a disregard of the message 130 by the human traffic participant. But when the human traffic participant conduct aligns with the desired conduct indicated by the message 130, the human traffic participant conduct data 422 operates to indicate a pedestrian motion in addition to an attention aspect by a human traffic participant, but also a conduct aspect that further may confirm an understanding to promote viable vehicle-to-human communication.

As may be appreciated, a human traffic participant may be considered proximal while the autonomous vehicle 100 may engage a traffic yield condition. For example, a pedestrian, bicyclist and/or a manually-operated vehicle may arrive to the traffic yield condition subsequent to the autonomous vehicle 100 transitioning from a stop and/or yield state (having message data 416 indicating “stopping” or “slowing”) to a “proceed” state (having message data 416 indicating “moving”).

Although the vehicle 100 may indicate “moving” via message data 416 (which may be conveyed via message 130), the vehicle-to-human communication module 400 may detect a human traffic participant being proximal to the traffic yield condition of the vehicle planned route 134. The attention data 420 may indicate that the autonomous vehicle 100 may have the attention of the human traffic participant to the message 130. However, the autonomous vehicle 100 may return to a stop and/or yield state (having message data 416 indicating “stopping” or “slowing”)

When the pedestrian acknowledges the receipt of the message 130, the acknowledgement confirmation module 418 may operate to generate vehicle acknowledgment message data 424 for broadcast to the human traffic participant. In this manner, the dialogue for a vehicle-to-human communication may be considered complete. The vehicle acknowledgment message data 424 may include a graphic user interface acknowledgment message for display via the external display 120, the vehicle audio system, the vehicle signaling devices such as blinkers, brake lights, and hazard lights, etc.

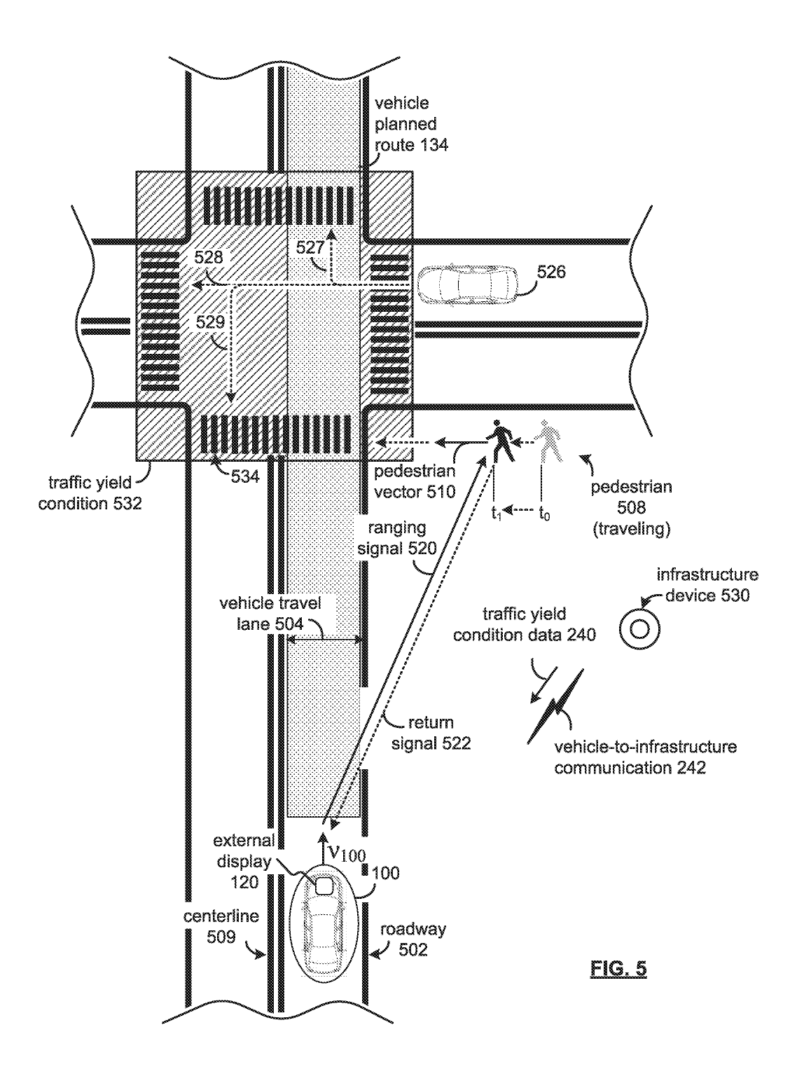

FIG. 5 illustrates a functional example of the vehicle-to-human communication module 400 of FIG. 4 for use in autonomous vehicle operations. The vehicle 100 is illustrated as traveling a roadway 502 at a velocity V₁₀₀ in a vehicle travel lane 504 of a plurality of travel lanes, and a centerline 509. In operation, the

The autonomous vehicle 100 may travel at a variable velocity V₁₀₀, in regard to a vehicle planned route 134, which may be defined by a present location and a destination, which may be entered by a vehicle operator at the vehicle 100 and/or remotely. Locations of the vehicle and achieving the destination objective may be conducted under location data technologies, such as GPS, GLONASS (GLObal Navigation Satellite System), ASPN (All Source Positioning and Navigation), based on IOT (Internet Of Things) technologies, etc., and/or combinations thereof. Also, vehicle location may be determined based on present viewed marker points (by vehicle sensors), which may be compared to mapped marker points.

The vehicle planned route 134, with the present vehicle location and destination, may be defined based on map layer data, such as via a Route Network Description File (RNDF) that may specify, accessible road segments (such as roadway 502) and information such as waypoints, lane widths, checkpoint locations, parking spot locations, traffic yield conditions 532 (such as stop sign locations, traffic light locations, roadway intersections, traffic circles, cross-walks, etc.).

An infrastructure device 530 may also provide traffic yield condition data 240 via a vehicle-to-infrastructure communication 242. As may be appreciated, the infrastructure device 530 may operate to gather global and/or local information on traffic and road conditions. Based on the gathered information, the infrastructure device 530 may suggest and/or imposing certain behaviors to vehicles, such as autonomous vehicle 100. The suggestion and/or imposition of certain behaviors may include designating traffic yield condition 532 to the autonomous vehicle 532, and may further indicate an approach velocity (taking into account, for example, the Vienna Convention on Road Traffic).

Further, the traffic yield condition may be defined based on object recognition via vehicle sensor devices 102, 104 and/or 106. For example, vehicle sensor device data 216 may indicate an approaching stop sign, traffic signal, merge, or other traffic flow condition associated with a traffic yield.

In the example of FIG. 5, the traffic yield condition 532 may be defined as associated with an intersection, which may include “STOP” or “YIELD” signage, be an uncontrolled intersection without any signage, metered by a traffic light, etc. The traffic yield condition 532 indicates that an autonomous vehicle 100 to slow down and prepare to stop.

The autonomous vehicle 100 in operation may engage in vehicle-to-human communications by detecting a human traffic participant, such as manually-operated vehicle 526, and pedestrian 508. In the example of FIG. 5, the manually-operated vehicle 526, and pedestrian 508 are proximal to the traffic yield condition 532 of the vehicle planned route 134.

As may be appreciated, the vehicle 526 may already be at a stop and/or beginning to continue forward across the vehicle planned route 134. The manually-operated vehicle 526 may cross the vehicle planned route 134 by taking a right turn 527 to merge into a traffic flow, by proceeding straight 528, or by taking a left turn 529 to proceed opposite to the direction of the autonomous vehicle 100.

As also may be appreciated, the pedestrian 508 may be in motion (such as via a pedestrian vector 510 having a speed and a direction of travel), may be at a stop, and/or may be slowing to the traffic yield condition 534, such as crosswalks 532. The pedestrian may cross the vehicle planned route 134 by proceeding across the crosswalk 534 in front of the autonomous vehicle 100.

For clarity, the example of vehicle-to-human communication may be with respect to the pedestrian 508, with the understanding that similar vehicle-to-human communications described herein may be conducted with a human operating the vehicle 526.

In operation, the autonomous vehicle 100 is operable to detect a human traffic participant (that is, a pedestrian 508) traveling at a pedestrian vector 510, and being proximal to the traffic yield condition 532 of the vehicle planned route 134.

As maybe appreciated, the vehicle 100 may be operable to detect the pedestrian 508 via a ranging signal 520 and a return signal 522. The ranging signal 520 and the return signal 522 may be generated and received via sensor devices 102, 104 and/or 106 (FIGS. 1 and 2) to provide object recognition functionality. As illustrated in the example of FIG. 5, a motion vector 510 of the pedestrian 508 may be generated including a vector component (that is range) and a directional component (that is, angle) traveled during an interval from time t₀ to time t₁.

In response, the autonomous vehicle 100 may operate to generate a message 130 for broadcast to the pedestrian 508, and senses, via vehicle sensor devices 102, 104, and/or 106, whether the pedestrian 508 acknowledges receipt of the message 130.

A pedestrian 508 may acknowledge receipt of the message 130 that may be broadcast via an external display 120 including audio/visual capability. Referring briefly back to FIG. 4, a vehicle control unit 110 may sense whether a human traffic participant acknowledges receipt of the message 130 via at least one of human traffic participant conduct data 422 and human traffic participant attention data 420.

In the present example, human traffic participant attention data may operate to indicate that a pedestrian 508 focus is directed to the broadcast message of the vehicle 100 by looking, facing, gazing, gesturing, etc. towards the vehicle 100. That is, attention may be determined based on sensing a human eye gaze directed towards a direction of the vehicle, by a gesture (such as waving the vehicle on) being directed towards the direction of the vehicle 100, and/or by a facial recognition indicating the human faces the direction of the vehicle 100.

To further corroborate the understanding inferred by the human traffic participant attention data (such as gaze tracking, eye-tracking, facial recognition, etc.), the vehicle control unit 110 may determine human traffic participant conduct data 422 may operate to indicate compliance and/or understanding of the message content 130 by the pedestrian 508.

When the pedestrian 508 conduct aligns with the desired conduct indicated by the message 130, the human traffic participant conduct data may operates to indicate a modified pedestrian vector 510 that avoids the vehicle planned route 134.

For example, pedestrian conduct data may operate to indicate that a pedestrian speed slows to yield with the traffic yield condition 532. As another example, the pedestrian conduct data may operate to indicate that the pedestrian 508 proceeds in a direction other than that of the vehicle 100. For example, the pedestrian turns right, crossing in front of the vehicle 526, which does not cross a vehicle planned route 134.

When the vehicle control unit 110 senses a human traffic participant (that is, pedestrian 508) acknowledges the receipt of the message 130, the vehicle control unit 110 may operate to generate a vehicle acknowledgment message data for broadcast to the pedestrian 508 In this manner, the dialogue for a vehicle-to-human communication may be considered complete.

The vehicle acknowledgment message data 424 may include a graphic user interface acknowledgment message for broadcast to the human traffic participant 508 (such as, a smiley face graphic, a thumbs-up graphic, an audible thank you (directionally broadcast to the pedestrian 508), etc.). The content may be displayed via the external display 120, an external audio system, vehicle blinker lights, vehicle brake lights, vehicle hazard lights, vehicle head lights, etc., and/or combinations thereof. etc.

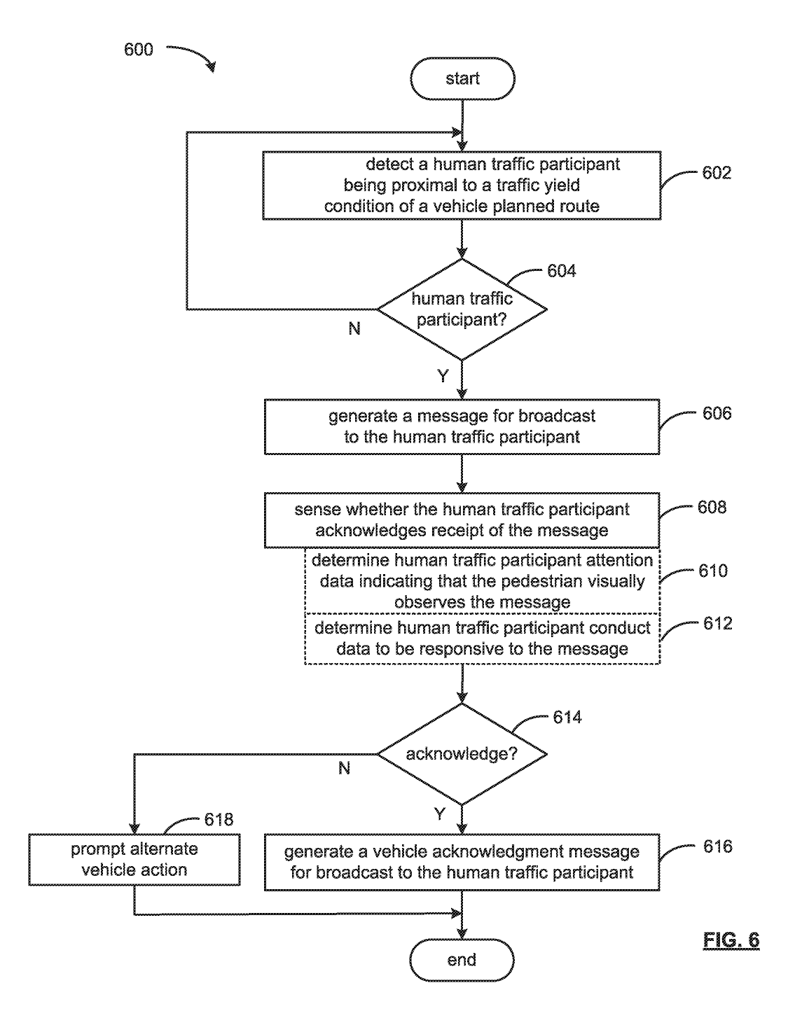

FIG. 6 shows an example process 600 for vehicle-to-human communications.

At operation 602, the process 600 detects a human traffic participant being proximal to a traffic yield condition of a vehicle planned route. As noted, a human traffic participant is one that participates in the flow of a roadway, either through a vehicle roadway portion (such as for autonomous vehicle 100) or through a pedestrian roadway portion (such as for a pedestrian, bicyclist, etc.). Sensor data may be analyzed to detect human traffic participant activity indicative of a human traffic participant being proximal to a traffic yield condition of the vehicle planned route.

At operation 604, when a human traffic participant is proximal to the traffic yield condition, at operation 606 the process generates a message for broadcast to the human traffic participant. The message generated at operation 608 may be broadcast via an external display of the autonomous vehicle (such as on a vehicle surface, inside a window surface, etc.), an external vehicle audio system, vehicle blinker lights, vehicle brake lights, vehicle hazard lights, vehicle head lights, etc., and/or combinations thereof.

Otherwise, the process returns to operation 602 to detect whether a human traffic participant being proximal to a traffic yield condition of a vehicle planned route.

At operation 608, the process 600 senses whether the human traffic participant acknowledges receipt of the message. Acknowledgment by a human traffic participant may be considered to be actions taken to recognize the rights, authority, or status of the autonomous vehicle as it travels a roadway of the vehicle planned route, as well as to disclose knowledge of, or agreement with, the message content broadcast by the vehicle. In general, acknowledgement by a human traffic participant may be based on at least one of human traffic participant attention data of operation 610 (that is, indicators that human traffic participant likely viewed and/or heard the message), and human traffic participant conduct data of operation 612 (that is, indicating that the human traffic participant received the message data content, and conducts itself in response to the message data content).

For example, the message content example display content may include a pedestrian icon having a “don't” circle and cross line, indicating that the vehicle 100 is not yielding. A human traffic participant may attempt a dialogue with the autonomous vehicle, through gaze tracking, motion recognition (e.g., waving, continued intercept motion with the vehicle planned route 134, etc.), which the vehicle may respond by generating a vehicle acknowledgment message for broadcast to the pedestrian.

From the perspective of an autonomous vehicle, acknowledgement by a human traffic participant may be based on (a) attention by the human traffic participant indicating visual observing/hearing the content of operation 610, and (b) human traffic participant conduct representing knowledge of, or agreement with, the message content broadcast by the vehicle in operation 612. Other additional forms to develop an acknowledgement that may be sensed by the autonomous vehicle may be implemented with respect to at least one of the examples of operations 610 and 612, as indicated by the hashed lines.

With respect human traffic participant attention of operation 610, sensor data may operate to indicate that a human traffic participant's focus is directed to the broadcast message of the vehicle by looking, facing, gazing, gesturing, etc., towards the autonomous vehicle. That is, attention by the human traffic participant may be determined based on a gaze directed towards a direction of the vehicle, a gesture (such as waving the vehicle on) being directed towards the direction of the vehicle, and/or a facial recognition indicating the human traffic participant facing a direction of the vehicle.

At operation 614, when the process 600 senses that a human traffic participant acknowledges the receipt of the message, at operation 616, the process 600 generates a vehicle acknowledgment message for broadcast to the human traffic participant (for example, a visual and/or audible thank you displayed via an external display and/or conveyed via vehicle lights).

In the alternative, when a human traffic participant acknowledgement may not be sensed by the autonomous vehicle alternate vehicle action at operation 620 may be undertaken (such as continued stop for a period of time sufficient to no longer detect a human traffic participant proximal to the traffic yield condition.

While particular combinations of various functions and features of the present invention have been expressly described herein, other combinations of these features and functions are possible that are not limited by the particular examples disclosed herein are expressly incorporated within the scope of the present invention.

As one of ordinary skill in the art may appreciate, the term “substantially” or “approximately,” as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items range from a difference of a few percent to magnitude differences.

As one of ordinary skill in the art may further appreciate, the term “coupled,” as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (that is, where one element is coupled to another element by inference) includes direct and indirect coupling between two elements in the same manner as “coupled.”

As one of ordinary skill in the art will further appreciate, the term “compares favorably,” as may be used herein, indicates that a comparison between two or more elements, items, signals, etc., provides a desired relationship. For example, when the desired relationship is that a first signal has a greater magnitude than a second signal, a favorable comparison may be achieved when the magnitude of the first signal is greater than that of the second signal, or when the magnitude of the second signal is less than that of the first signal.

As the term “module” may be used herein in the description of the drawings, a module includes a functional block that is implemented in hardware, software, and/or firmware that performs one or more functions such as the processing of an input signal to produce an output signal. As used herein, a module may contain submodules that themselves are modules.

Thus, there has been described herein an apparatus and method, as well as several embodiments including a preferred embodiment, for implementing vehicle-to-human communications as may relate to perceived in relation to traffic yield conditions.

The foregoing description relates to what are presently considered to be the most practical embodiments. It is to be understood, however, that the disclosure is not to be limited to these embodiments but, on the contrary, is intended to cover various modifications and equivalent arrangements included within the spirit and scope of the appended claims, which scope is to be accorded the broadest interpretations so as to encompass all such modifications and equivalent structures as is permitted under the law.

1. A method for vehicle-to-human communication operable for autonomous vehicle operation, the method comprising:
detecting a human traffic participant being proximal to a traffic yield condition of a vehicle planned route;
generating an action message indicating a vehicle intent for broadcast to the human traffic participant;
sensing, by a vehicle sensor device, whether the human traffic participant acknowledges receipt of the action message by at least one of:
determining, by at least one processor, human traffic participant attention data indicating that the human traffic participant visually observes the action message; and
determining, by the at least one processor, human traffic participant movement data to be responsive to the action message; and
when the human traffic participant acknowledges the receipt of the action message, generating a vehicle acknowledgment message for broadcast to the human traffic participant.

2. The method of claim 1, further comprising:
when either of the human traffic participant attention data and the human traffic participant movement data are contrary to the action message, generating a counter-action message responsive to the either of the human traffic participant attention data and the human traffic participant movement data.

3. The method of claim 1, wherein the generating the action message comprises at least one of:
a graphic-based message for display by an external display of the vehicle; and
an audible message for playback from the vehicle.

4. The method of claim 1, wherein the human traffic participant attention data comprises at least one of:
a human traffic participant gaze directed towards a direction of the vehicle;
a human traffic participant gesture directed towards the direction of the vehicle; and
a facial recognition indicating the human traffic participant is facing the direction of the vehicle.

5. The method of claim 1, wherein the human traffic participant movement data comprises at least one of:
the action message conveying a human traffic participant velocity vector component slowing to a pedestrian travel rate that operates to avoid interception of the vehicle planned route; and
modifying a directional component to one that operates to avoid intercepting the vehicle planned route.

6. The method of claim 1, wherein the vehicle acknowledgement message comprises at least one of:
a graphic user interface acknowledgment message for display via the external display; and
an audible acknowledgment message for directional announcement by a speaker of the vehicle.

7. The method of claim 1, wherein the traffic yield condition may be defined by at least one of:
Route Network Description File (RNDF) data;
traffic yield condition data; and
object recognition data relating to the traffic yield condition for the vehicle planned route.

8. A method in a vehicle control unit for autonomous operation of a vehicle, the method comprising:
detecting a human traffic participant being proximal to a traffic yield condition of a vehicle planned route;
generating an action message indicating a vehicle intent for broadcast to the human traffic participant;
sensing, by a vehicle sensor device, whether the human traffic participant acknowledges receipt of the action message by:
determining, by at least one processor, human traffic participant attention data indicating that the human traffic participant visually observes the action message; and
determining, by the at least one processor, human traffic participant movement data to be responsive to the action message; and
when the human traffic participant acknowledges the receipt of the action message, generating a vehicle acknowledgment message for broadcast to the human traffic participant.

9. The method of claim 8, further comprising:
when either of the human traffic participant attention data and the human traffic participant movement data are contrary to the action message, generating a counter-action message responsive to the either of the human traffic participant attention data and the human traffic participant movement data.

10. The method of claim 8, wherein the generating the action message comprises at least one of:
a graphic-based message for display by an external display of the vehicle; and
an audible message for playback from the vehicle.

11. The method of claim 8, wherein the human traffic participant attention data comprises at least one of:
a human traffic participant gaze directed towards a direction of the vehicle;
a human traffic participant gesture directed towards the direction of the vehicle; and
a facial recognition indicating the human traffic participant is facing the direction of the vehicle.

12. The method of claim 8, wherein the human traffic participant movement data comprises at least one of:
the action message conveying a human traffic participant velocity vector component slowing to a pedestrian travel rate that operates to avoid interception of the vehicle planned route; and
modifying a directional component to one that operates to avoid intercepting the vehicle planned route.

13. The method of claim 8, wherein the vehicle acknowledgement message comprises at least one of:
a graphic user interface acknowledgment message for display via the external display; and
an audible acknowledgment message for directional announcement by a speaker of the vehicle.

14. The method of claim 8, wherein the traffic yield condition may be defined by at least one of:
Route Network Description File (RNDF) data;
traffic yield condition data received from a vehicle-to-infrastructure device; and
object recognition data prompting the traffic yield condition for the vehicle planned route.

15. A vehicle control unit for providing vehicle-to-human communications in an autonomous vehicle operation, the vehicle control unit comprising:
a processor;
memory communicably coupled to the processor and to a plurality of vehicle sensor devices, the memory storing:
a vehicular operations module including instructions that when executed cause the processor to generate vehicle location data including a traffic yield condition from vehicle planned route data and sensor data;
a traffic yield condition module including instructions that when executed cause the processor to:
receive the vehicle location data and human traffic participant data, based on at least some of the plurality of vehicle sensor devices, to detect a human traffic participant being proximal to the traffic yield condition;
when the human traffic participant is proximal to the traffic yield condition, generate message data indicating a vehicle intent for delivery to the human traffic participant; and
an acknowledgment confirmation module including instructions that when executed cause the processor to sense, based on the at least some of the plurality of vehicle sensor devices, whether the human traffic participant acknowledges a receipt of the message by at least one of:
determining human traffic participant attention data indicating whether the human traffic participant comprehends the message; and
determining human traffic participant conduct data responsive to the message;
wherein the acknowledgement confirmation module includes further instructions to, upon sensing that the human traffic participant acknowledges the receipt of the message, generate a vehicle acknowledgment message for delivery to the human traffic participant.

16. The vehicle control unit of claim 15, wherein the message comprises at least one of:
a graphic-based message for an external display of the vehicle; and
an audible message for announcement by the vehicle.

17. The vehicle control unit of claim 15, wherein the acknowledgment message comprises at least one of:
a graphic-based acknowledgment message for display by an external display of the vehicle; and
an audible acknowledgment message for announcement by an audio system of the vehicle.

18. The vehicle control unit of claim 15, wherein the human traffic participant attention data comprises at least one of:
a human traffic participant gaze directed towards a direction of the vehicle;
a human traffic participant gesture directed towards the direction of the vehicle; and
a facial recognition indicating that the human traffic participant faces a direction of the vehicle.

19. The vehicle control unit of claim 15, wherein the human traffic participant conduct comprises at least one of:
a human traffic participant velocity vector component slowing to a pedestrian travel rate that yields to the vehicle planned route; and
modifying a human traffic participant vector directional component to one that operates to avoid the vehicle planned route.

20. The vehicle control unit of claim 15, wherein the traffic yield condition may be defined by at least one of:
Route Network Description File (RNDF) data;
traffic yield condition data; and
object recognition data relating to the traffic yield condition for the vehicle planned route.
